(19) United States
(12) Patent Application Publication
(10) Pub. No.: US 2004/0204545 A1
(43) Pub. Date: Oct. 14, 2004

(54) Toughened nylon compositions with improved flow and processes for their preparation

(76) Inventors: Rolando Umali Pagilagan, (US); Robert Benham Fish JR., (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/833,858

(22) Filed: Apr. 28, 2004

Related U.S. Application Data
(63) Continuation of application No. 10/095,905, filed on Mar. 11, 2002, now abandoned.
Application No. 10/095,905 is a continuation-in-part of application No. 09/668,907, filed on Sep. 22, 2000, now abandoned.
(60) Provisional application No. 60/155,628, filed on Sep. 23, 1999.

(51) Int. Cl. C08L 77/00

(52) U.S. Cl. 525/184; 525/420

(57) ABSTRACT

Rubber-toughened and ionomer-toughened polyamide compositions are provided which exhibit decreased molecular weight in comparison with conventional systems but without compromising the toughness of the system. Processes for their preparation are also provided, in which excess organic acid is incorporated into the polyamide-functionalized rubber system.

### FIELD OF THE INVENTION

This invention relates to toughened polyamide compositions and processes for their preparation. More specifically, this invention relates to such compositions toughened with rubber or ionomer, which incorporate organic acids to desirably decrease viscosity but without significantly reducing the toughness thereof, together with methods for their preparation.

### BACKGROUND OF THE INVENTION

High flow (or low melt viscosity, as these terms are used interchangeably) is a very desirable characteristic of an injection molding resin. A resin with higher flow or lower melt viscosity can be injection molded with greater ease compared to another resin which does not possess this characteristic. Such a resin has the capability of filling a mold to a much greater length at lower injection pressures and temperatures and greater capability to fill intricate mold designs with thin cross-sections. It is well known that the melt viscosity of a polymer is directly proportional to its molecular weight. It is also well known that the melt viscosity of a polymer, especially at low shear rates are much higher for a branched polymer compared to a linear polymer at the same molecular weight. It is also well known that polyamide polymers react with organic acids and amines when added in the melt causing a reduction in its molecular weight. This method is sometimes used to increase the flow or lower the melt viscosity of a polyamide polymer.

The presence of a dispersed phase such as mineral and glass reinforcements in a polymer results in increased melt viscosity. The presence of a dispersed phase of an incompatible polymer also results in an increase in the melt viscosity. To be able to form a stable dispersion, the toughener is generally functionalized with for example, anhydride or epoxide. Thus, generally, rubber-toughened polyamides containing dispersed rubber have melt viscosities much higher than the original polyamide polymer. It is also well known that to obtain good toughness and to optimize dispersion of incompatible polymers such as olefin rubbers and/or ionomers with polyamides, the melt viscosities of the two polymers must be fairly close to each other.

The advantages of reduced viscosity resins are well known to those skilled in the practice of injection molding. However, the most highly desirable combination of properties was previously not available. For example, tougheners such as are disclosed in U.S. Pat. No. 4,174,358, incorporated herein by reference, can be utilized in improving the toughness of polyamide resins by melt blending polyamide resins with low tensile modulus copolymers that have adherent sites to obtain a highly toughened polyamide material. However, addition of tougheners also increases the viscosity of the resin. This fact has inevitably led to compromises in property selection.

Preparation of tough, high melt flow polyamides has also been addressed somewhat in the literature. For example, U.S. Pat. No. 5,274,033 discloses blending of low molecular weight polyamide into the toughened polyamide blend as a route to production of a high flow toughened polyamide. While quite suitable, this has the disadvantage of adding expensive process steps such as preparation of the low molecular weight polyamide. Meeting the objective of producing high melt flow toughened polyamides in an easily commercial step had previously eluded the trade.

It is an object of the present invention to provide toughened nylon compositions exhibiting improved flow as compared to conventional resins during injection molding operations. It is a further object of the invention to provide rubber or ionomer-toughened nylon compositions that exhibit such desirable flow characteristics while not detracting from their toughness. A feature of the present invention is its applicability across a wide range of process conditions. An advantage of the invention is the incorporation of organic acids into the polyamide-functionalized rubber or ionomer system to enhance flow but without sacrificing toughness properties. These and other objects, features and advantages will become better appreciated upon having reference to the following description of the invention herein.

### SUMMARY OF THE INVENTION

Toughened polyamide compositions are provided, comprising:

(a) 40-94 percent by weight polyamide;

(b) 6-60 percent by weight toughener selected from the group consisting of rubber and ionic copolymer; and

(c) up to 10 percent by weight organic acid.

Useful polyamides in conjunction with the compositions of the invention include those listed throughout the description, together with blends and copolymers thereof. The toughener is preferably used in amounts of from about 8 to about 40 percent by weight, and most preferably from about 10 to about 30 percent by weight.

In a preferred embodiment of the invention, the polyamide compositions comprise 50-94 weight percent polyamide, 6-50 weight percent of the toughener, and up to 10 weight percent of organic acid.

Any number of organic acids may be selected. Organic acids are organic compounds of C, H, and O containing one or more carboxylic acid functionalities. Examples of suitable organic acids include adipic acid, pimelic acid, suberic acid, azelaic acid, sebacic acid, undecanedioic acid, and dodecanedioic acid (all dicarboxylic acids); and, valeric acid, trimethylacetic acid, caproic acid, and caprylic acid (all monocarboxylic acids). Dodecanedioic acid (“DDDA”) is of particular interest.

There is also disclosed and claimed herein processes for the preparation of toughened polyamide compositions exhibiting high flow and toughness, comprising melt-mixing in a conventional extruder 40-94 percent by weight polyamide, 6-60 percent by weight toughener selected from the group consisting of rubber and ionic copolymer, and up to 10 percent by weight organic acid.

There are many process variations contemplated herein. For example, the polyamide, toughener and organic acid may be melt-mixed as one step; a blend of polyamide and toughener may be melt-mixed with the acid; or polyamide and toughener may be blended and subsequently melt-mixed with the acid. Further, melt-mixing may be effected by extrusion or molding alone or in combination.

### DETAILED DESCRIPTION OF THE INVENTION

A process is herein provided for the manufacture of rubber-toughened nylon compositions with improved flow during injection molding. It has been discovered that a rubber-toughened nylon composition can be produced by the addition of organic acids added during the melt compounding step.

Rubber-toughened polyamide compositions have been commercially available for more than twenty years. The technology involves incorporating an olefinic rubber in the polyamide. This is often done in the melt phase. The rubber dispersion must be fairly stable, i. e., the rubber phase must not coalesce substantially during subsequent melt processing such as injection molding. Since olefinic rubbers are incompatible with polyamides, it is necessary to modify the rubber with functional groups that are capable of reacting with the acid or amine ends in the polyamide polymer. The reaction of an anhydride with amine is very fast, therefore, an anhydride is often the functionality of choice. When an incompatible olefinic rubber with an anhydride functionality is mixed with a polyamide, the anhydride functionality of the rubber reacts with the amine ends of the polyamide resulting in the rubber becoming grafted on the polyamide molecule. This molecular bonding minimizes coalescence of the rubber phase.

The use of ionic copolymers to produce toughened nylon blends is well known in the art. See for example U.S. Pat. No. 3,845,163 which discloses blends of nylon and ionic copolymers. Further, U.S. Pat. No. 5,688,868 discloses the preparation of such toughened blends wherein the ionic copolymer is prepared in-situ with very high levels of neutralization. U.S. Pat. No. 5,091,478 discloses flexible thermoplastic blends wherein the nylon component may be between 25-50 volume % with the polyamide comprising at least one continuous phase of the composition. Finally, U.S. Pat. No. 5,866,658 covers ionomer/polyamide blends in the range 40-60 weight percent ionomer and 60-40 weight percent polyamide. The present invention may be applied to the types and ranges of ionic copolymers as disclosed therein.

The reaction between the functionality of the toughener and the end groups of the polyamide is necessary for the grafting to occur. For example, with the anhydride-amine end, reaction is necessary in order for the rubber toughening to occur. Any significant interference with this reaction will impact negatively on the toughening. It is also important that the melt viscosities of the rubber and the polyamides are close to each other to accomplish good dispersion. The discovery herein involves a process for the preparation of a rubber-toughened polyamide wherein excess organic acid is incorporated in the polyamide-functionalized rubber system without negative impact on the toughness of the system. Without intending to be limited to any particular theory, it is thought that the added organic acids react with the polyamide decreasing the polyamide molecular weight and its melt viscosity without apparent interference with the toughening chemistry. This is very surprising because the expected interference of the organic acids on the anhydride-amine end reaction and the negative effect of lowered melt viscosity did not have an impact on toughness.

Those skilled in the art will appreciate that the above described benefits are suitable for a wide range of polyamide compositions. Without intending to limit the generality of the foregoing, the following are of particular interest:

Polyamides selected from the group consisting of nylon-4,6, nylon-6,6, nylon-6,10, nylon-6,9, nylon-6,12, nylon-6, nylon-I1, nylon-1 2, 6T through 12T, 6I through 12I, polyamides formed from 2-methylpentamethylene diamine with one or more acids selected from the group consisting of isophthalic acid and terephthalic acid, and blends and copolymers of all of the above.

Notched Izod toughnesses of at least 3.0 ft-lb/in (however, compositions featuring lower Notched Izod values are observed as the rubber or ionomer content is decreased).

The polyamides disclosed herein are also used in blends with other polymers to produce engineering resins. The blends of this invention may also contain certain additional polymers that could partially replace the polyamide component. Examples of such additional polymers are melamine formaldehyde, phenol formaldehyde (novolac), polyphenylene oxide (see for example EP 0 936 237 A2), polyphenylene sulfide, polysulfone and the like. These polymers can be added during the mixing step. It will be obvious to those skilled in the art that the present invention relates to modification of the polyamide component and that additional polymers could be added appropriately without departing form the spirit of this present invention.

Representative tougheners useful in the practice of this invention include many branched and straight chain polymers and block copolymers and mixtures thereof. These are represented by the formula:

A₍ₐ₎-B_{(b})-C_{(c)}-D_{(d)}-E₍ₑ₎-F_{(f)}-G_{(g)}-H₍ₕ₎

derived in any order, e.g., random, from monomers A to H where

A is ethylene;

B is CO;

C is an unsaturated monomer taken from the class consisting of a β-ethylenically unsaturated carboxylic acids having form 3 to 8 carbon atoms, and derivatives thereof taken from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having from 0 to 100 percent of the carboxylic acid groups ionized by neutralization with metal ions and dicarboxylic acids and monoesters of the dicarboxylic acid neutralized by amine-ended caprolactain oligomers having a DP to 6 to 24;

D is an unsaturated epoxide of 4 to 11 carbon atoms;

E is the residue derived by the loss of nitrogen from an aromatic sulfonyl azide substituted by carboxylic acids taken from the class consisting of monocarboxylic and dicarboxylic acids having from 7 to 12 carbon atoms and derivatives thereof taken from the class consisting of monoesters of alcohols of 1 to 29 carbon atoms and the dicarboxylic acids and anhydrides of the dicarboxylic acids and the metal salts of the monocarboxylic, dicarboxylic acids and the monoester of the dicarboxylic acid having form 0 to 100 percent of the carboxylic acid groups ionized by neutralization with metal ions;

F is an unsaturated monomer taken form the class consisting of acrylates esters having form 4 to 22 carbons atoms, vinyl esters of acids having form 1 to 20 carbon atoms (substantially no residual acid), vinyl ethers of 3 to 20 carbon atoms, and the vinyl and vinylidene halides, and nitrites having from 3 to 6 carbon atoms;

G is an unsaturated monomer having pendant hydrocarbon chains of 1 to 12 carbon atoms capable of being grafted with monomers having at least one reactive group of the type defined in C, D and E, and pendant aromatic groups which my have 1 to 6 substituent groups having a total of 14 carbon atoms; and

H is an unsaturated monomer taken from the class consisting of branched, straight chain and cyclic compounds having from 4 to 14 carbon atoms and at least one additional nonconjugated unsaturated carbon-carbon bond capable of being grafted with a monomer having at least one reactive group of the type defined in C, D and E.

The aforementioned monomers may be present in the polymer in the following mole fraction:

(a) 0 to 0.95;

(b) 0 to 0.3;

(c) 0 to 0.5;

(d) 0 to 0.5;

(e) 0 to 0.5;

(f) 0 to 0.99;

(g) 0 to 0.99; and

(h) 0 to 0.99

so that the total of all components is a mole fraction of 1.0.

Preferably (a) to (h) are present in the following mole fraction:

(a) 0 to 0.9;

(b) 0 to 0.2, most preferably 0.1 to 0.2

(c) 0.0002 to 0.2 most preferably 0.002 to 0.05;

(d) 0.005 to 0.2, most preferably 0.01 to 0. 1;

(e) 0.0002 to 0.1, most preferably 0.002 to 0.01;

(f) 0 to 0.98;

(g) 0 to 0.98; and

(h) 0 to 0.98

The blends of this invention may also contain one or more conventional additives such as stabilizers and inhibitors of oxidative, thermal, and ultraviolet light degradation, lubricants and mold release agents, colorants including dyes and pigments, flame-retardants, plasticizers, and the like. These additives are commonly added during the mixing step. They may be added in effective amounts as is readily appreciated by those having skill in the art.

Representative oxidative and thermal stabilizers which may be present in blends of the present invention include halide salts, e.g., sodium, potassium, lithium with copper salts, e.g., chloride, bromide, iodide; hindered phenols, hydroquinones, and varieties of substituted members of those groups and combinations thereof.

Representative ultraviolet light stabilizers, include various substituted resorcinols, salicylates, benzotriazoles, benzophenones, and the like.

Representative lubricants and mold release agents include stearic acid, stearyl alcohol, and stearamides. Representative organic dyes include nigrosine, while representative pigments, include titanium dioxide, cadmium sulfide, cadmium selenide, phthalocyanines, ultramarine blue, carbon black, and the like.

Representative flame-retardants include organic halogenated compounds such as decabromodiphenyl ether and the like.

The toughener can be used in neat or diluted form. In the latter case, either EPDM, EPR, or polyethylene can be used as the diluent.

### EXAMPLES

The invention is illustrated by the following Examples and Comparative Examples herein. Melt Viscosity data were obtained at 280 C using a commecial rheometer such at the Kayeness Rheometer, Model 8052. Notched Izod toughness were determined in accordance with ASTM D256 at room temperature on a 5″×½″×⅛″ specimens, or with ISO 527-2C at room temperature an a 4 mm thick×80 mm in length specimen.

### Comparative Example 1

A pellet blend of 141.8 lb of nylon 66 under the tradename ZYTEL® 101 (available from E.I. duPont de Nemours and Co., Wilmington, Del.) and 33.2 lb of anhydride functionalized rubber under the tradename FUSABOND® N MF521D (available from E.I. duPont de Nemours and Co.) was introduced into the first barrel of a ten-barrel 53 mm Werner & Pfleiderer twin-screw extruder at a rate of 300 lb/hr, extruder RPM of 250 with a high shear screw, and vacuum of 14″-15″ applied on barrel 9. The melt temperature during the extrusion process was 329 C. The polymer strands coming from the extruder were quenched in water and fed to a cutter. The hot pellets were collected in a vessel that was continuously swept with nitrogen gas to avoid moisture absorption from the air.

### Example 1

Example 1 was prepared in the manner described for Comparative Example 1 above from a pellet blend of 140.9 lb of ZYTEL® 101, 33.2 lb of FUSABOND® N MF521D, and 397.2 g of dodecanedioic acid. Using the same extruder conditions as in the Comparative Example and a rate of 300 lb/hr, the melt temperature during extrusion was 314 C. The polymer strands coming from the extruder were quenched in water and fed into a cutter. The hot pellets were collected in a vessel that was continuously swept with nitrogen gas.

### Example 2

A pellet blend of 135.1 lb of ZYTEL® 101 and 39.9 lb of FUSABOND® N MF52 1D was introduced into the first barrel of a ten-barrel 53 mm Werner & Pfleiderer twin-screw extruder at 250 lb/hr using same conditions as Comparative Example 1. At the same time a blend of 169.8 lb ZYTEL® 101 and 5.2 lb of dodecanedioic acid was introduced into barrel #7 at a rate of 50 lb/hr. This composition is equivalent to Example 1. The melt temperature during extrusion was 312 C. The polymer strands coming from the extruder were quenched in water and fed into a cutter. The hot pellets were collected in a vessel that was continuously swept with nitrogen gas.

A comparison of the results of this work is provided in Table 1 below.

TABLE 1

| | Notched | Melt Viscosity (Pa-S) @ | | |
|---|---|---|---|---|
| | Izod | Various Shear Rates | | |
| Sample | (ft-lb/in) | 100 1/sec | 1000 1/sec | 2999 1/sec |
| Comparative Example 1 | 19.99 | 920 | 165 | 78 |
| Example 1 | 19.00 | 494 | 96 | 48 |
| Example 2 | 19.52 | 481 | 111 | 47 |

The results above show that in the presence of the dodecanedioic acid there was a dramatic decrease in melt viscosity. The change in melt viscosity also is essentially unaffected by the location of the where the dodecanedioic acid is introduced. The results also show that there is essentially no change in the Notched Izod toughness in the presence of the diacid.

### Comparative Examples 2-3 and Example 3

In the following series of experiments the ingredients were melt blended with each other under high shear. The various ingredients may first be dry blended with each other by tumbling in a drum or they may be combined with one another via simultaneous or separate metering of one or more of the components. Preferably the melt blending will be done in a twin screw extruder manufactured by Werner & Pfleiderer or Berstorff, although numerous other high shear melt blending devices, apparent and well known to those skilled in the art, may be used.

Table 2 shows re-extrusion of a polyamide blend together with the dodecanedioic acid. The polyamide blend and dodecanedioic acid feeds were controlled by dry blending and feeding with a single metering device. The ingredients were blended by tumbling 74.5 pounds. ZYTEL® ST801HS NC010 (a rubber-toughened 6,6-nylon available commercially from E. I. DuPont de Nemours & Co.) and 221.3 grams dodecanedioic acid (available commercially from E. I. DuPont de Nemours & Co.) in a drum. The blended ingredients were fed into the extruder by a K-Tron loss-in-weight screw feeder running at 180 lb/hr. In this case the melt blending occurred in a 40 mm Werner & Pfleiderer twin screw extruder operating 300 rpm screw speed with a high shear screw. The ingredients were fed into barrel 1 with a screw feeder. A vacuum was applied at barrel 8. After exiting through a 4-hole die, the strands were quenched in an ambient water trough with circulating water. The strands were subsequently pelletized and allowed to cool under nitrogen sparge.

TABLE 2

| Ingredient (weight %) | Example 3 | Comp Ex 2 | Comp Ex 3 |
|---|---|---|---|
| ZYTST801HS NC010 | 99.35% | 100.00% | 100.00% |
| Dodecanedioic Acid | 0.65% | | |
| Notched Izod, DAM, | 63.37 | 69.7 | 59.28 |
| 23° C., kJ/m² | | | |
| Melt viscosity, Pa-S | 96 | 198 | 182 |

This series of examples demonstrates that the benefits and attributes of the invention herein are recognized even with the addition of the acid as a separate step. The commercial grade of nylon selected as above is already rubber-toughened, and the subsequent introduction of the acid still imparted the desirable enhancement in melt viscosity without compromising the toughness. This is illustrative of the range of applicability of the process and compositions of the invention, and for example is well suited for injection-molding applications.

### Comparative Example 4 and Examples 4-6

This series of examples shows the applicability of dodecanedioic acid in reducing the viscosity of nylon/ionic polymer blends without degrading physical properties.

Table 3 shows compositions containing nylon 66 as the thermoplastic polyamide and an ionic polymer as the toughening material together with the dodecanedioic acid sufficient to produce an appropriate degree of viscosity reduction. In these examples, the nylon and toughener feeds were controlled by separate metering. The ionic polymer feed stream was SURLYN® 9520W acid (available commercially from E. I. DuPont deNemours & Co.). It was fed by a K-Tron loss-in-weight screw feeder running at 31.6 lb/hr. The nylon feed stream was comprised of a 66-nylon polymer having an RV of approximately 50 and about 40 amine ends), copper-based heat stabilizer, Ampacet Black Concentrate 19238 (“Amp Bk 19238”) (available commercially from Ampacet Corp., Tarrytown, N.Y.), and optionally, dodecanedioic acid (available commercially from E. I. DuPont deNemours & Co.). The nylon feed stream ingredients were blended by tumbling in a drum. This feed stream was fed into the extruder by a K-Tron loss-in-weight screw feeder running at 148.4 lb/hr. In this case the melt blending occurred in a 40 mm Werner & Pfleiderer twin screw extruder operating 300 rpm screw speed with a high shear screw. The ingredients were fed into barrel 1 with a screw feeder. A vacuum was applied at barrel 8. After exiting through a 4-hole die, the strands were quenched in an ambient water trough with circulating water. The strands were subsequently pelletized and allowed to cool under nitrogen sparge.

TABLE 3

| Ingredient | Comp | Example | Example | Example |
|---|---|---|---|---|
| (weight %) | Ex 4 | 4 | 5 | 6 |
| HS711 | 0.003 | 0.003 | 0.003 | 0.003 |
| 66-nylon | 0.777 | 0.7745 | 0.772 | 0.7705 |
| polymer | | | | |
| SURLYN ® | 0.1755 | 0.1755 | 0.1755 | 0.1755 |
| 9520W | | | | |
| Amp Bk 19238 | 0.0445 | 0.0445 | 0.0445 | 0.0445 |
| DDDA | 0 | 0.0025 | 0.005 | 0.0065 |
| Notched Izod, | 18.5 | 17.02 | 16.76 | 17.04 |
| DAM, 23° C., | | | | |
| ft-lb/in | | | | |
| Melt Viscosity, | 146 | 110 | 91 | 87 |
| Pa-S | | | | |

NOTE:
HS711 is a physical blend of cuprous iodide/potassium iodide/aluminum distearate in the ratio of 7/1/1.

### Comparative Examples 5-6 and Examples 7-12

A series of experiments was conducted to illustrate the effect of high amounts of DDDA (up to 1.0 weight percent) on properties of nylon 66 compositions including 7.0 weight % and 19.0 weight % FUSABOND® N MF521D toughener. These compositions were prepared in the manner detailed in Comparative Example 1 and Example 1. The results are shown in Table 4. Surprisingly, even at 1.0 % DDDA there was only about a 14% decrease in the Notched Izod toughness at both low and high levels of toughener. There are enough acid equivalents at 1.0 % DDDA to react completely with the amine ends of the nylon

These results indicate that the composition of the invention is fairly robust across various levels of DDDA, and with this information one of ordinary skill in the art will readily appreciate that existing manufacturing equipment and procedures are capable of producing these types of products.

TABLE 4

| | | FUSA- | | Notched | Melt Viscosity(Pa-S) | | |
|---|---|---|---|---|---|---|---|
| Example or | | BOND ® N | | Izod | @Various Shear Rates | | |
| CompEx | NYLON 66 | MF521D, % | % DDDA | (ft-lb/in) | 100 1/sec | 1000 1/sec | 2999 1/sec |
| Comp Ex 5 | 93.00% Z101 | 7.00 | 0.00 | 1.84 | 239 | 87 | 29 |
| Example 7 | 92.50% Z101 | 7.00 | 0.50 | 1.98 | 119 | 64 | 21 |
| Example 8 | 92.35% Z101 | 7.00 | 0.65 | 1.90 | 104 | 46 | 21 |
| Example 9 | 92.00% Z101 | 7.00 | 1.00 | 1.58 | 62 | 14 | 14 |
| Comp Ex 6 | 81.00% Z101 | 19.00 | 0.00 | 13.42 | 967 | 203 | 68 |
| Example 10 | 80.50% Z101 | 19.00 | 0.50 | 12.40 | 498 | 117 | 39 |
| Example 11 | 80.35% Z101 | 19.00 | 0.65 | 12.53 | 397 | 89 | 41 |
| Example 12 | 80.00% Z101 | 19.00 | 1.00 | 11.69 | 267 | 80 | 27 |

### Comparative Example 7 and Examples 13-15

The following series of tests serve to illustrate the performance characteristics of blends of high flow polyamides toughened with ionomer. In this series no colorant is used. There is a clear demonstration of the applicability of dodecanedioic acid in reducing the viscosity of nylon/ionic polymer blends without degrading physical properties. The results are shown in Table 5.

Table 5 shows compositions containing nylon 66 as the thermoplastic polyamide and an ionic polymer as the toughening material together with the dodecanedioic acid sufficient to produce an appropriate degree of viscosity reduction. In these examples, the nylon and toughener feeds were controlled by separate metering. The ionic polymer feed stream was SURLYN® 9520W (available commercially from E. I. DuPont deNemours & Co.). It was fed by a

K-Tron loss-in-weight screw feeder running at 36 lb/hr. The 66-nylon feed stream was ZYTEL® 101 (available commercially from E. I. DuPont deNemours & Co.), and optionally, dodecanedioic acid (available commercially from E. I.

DuPont deNemours & Co.). The nylon feed stream ingredients were blended by tumbling in a drum. This feed stream was fed into the extruder by a K-Tron loss-in-weight screw feeder running at 144 lb/hr. In this case the melt blending occurred in a 40 mm Werner & Pfleiderer twin screw extruder operating 300 rpm screw speed with a high shear screw. The ingredients were fed into barrel 1 with a screw feeder. A vacuum was applied at barrel 8. After exiting through a 4-hole die, the strands were quenched in an ambient water trough with circulating water.

The strands were subsequently pelletized and allowed to cool under nitrogen sparge.

TABLE 5

| | Comp | Example | | |
|---|---|---|---|---|
| Ingredient (weight %) | Ex 7 | 13 | Example 14 | Example 15 |
| ZYTEL ® 101 | 80.000 | 79.65 | 79.50 | 79.35 |
| SURLYN ® 9520W | 20.00 | 20.00 | 20.00 | 20.00 |
| DDDA | 0 | 0.35 | 0.50 | 0.65 |
| Notched Izod, DAM, | 21.12 | 17.02 | 16.76 | 17.04 |
| 23° C., KJ/m² | | | | |
| Notched Izod, DAM, | 17.69 | 17.20 | 16.48 | 18.31 |
| 0° C., KJ/m² | | | | |
| Melt Viscosity, Pa-S | 111 | 79 | 67 | 58 |

### Comparative Example 8 and Examples 16-23

The following series of comparisons shows the effects of incorporating higher levels of DDDA into the composition.

Table Table 6 shows compositions containing various amounts of DDDA (up to 20 10.0 weight percent) on properties of nylon 66 compositions containing 19.0 weight % FUSABOND® N MF521D toughener. In these examples, the nylon, toughener and DDDA feeds were controlled by separate metering. The toughener polymer feed stream was FUSABOND® N MF521D (available commercially from E. I. DuPont deNemours & Co.). It was fed by a K-Tron loss-in-weight screw feeder running at 34.2 lb/hr. The 66-nylon feed stream was ZYTEL® 101 (available commercially from E. I. DuPont deNemours & Co.), and optionally, dodecanedioic acid (available commercially from E. I. DuPont deNemours & Co.). At DDDA levels below 5%, the nylon and DDDA were blended by tumbling in a drum and fed as one feed stream. This feed stream was fed into the extruder by a K-Tron loss-in-weight screw feeder running at 145.8 lb/hr. At DDDA levels of 5% and above, the nylon and DDDA feed streams were fed by separate metering. In these cases the melt blending occurred in a 40 mm Werner & Pfleiderer twin screw extruder operating 300 rpm screw speed with a high shear screw. The ingredients were all fed into barrel 1. A vacuum was applied at barrel 8. After exiting through a 4-hole die, the strands were quenched in an ambient water trough with circulating water. The strands were subsequently pelletized and allowed to cool under nitrogen sparge.

The results are shown in Table 6. It can be seen from these data that the DDDA continues to produce higher and higher flow blends over the entire range of this test. Although the toughness was adversely affected at 2% DDDA and above, by practicing at higher levels of toughener this property is not so negatively impacted. This is because increasing the toughener level allows the overall composition to tolerate more DDDA.

TABLE 6

| | ZYTEL ® | | | Notched Izod, | |
|---|---|---|---|---|---|
| | 101 | Fusabond ® | | DAM, 23, | |
| ID | NC010 | N MF521D | DDDA) | kJ/m2 | MV, Pa-S |
| Comp | 81.00% | 19.00% | 0.00% | 80.26 | 244 |
| Ex 8 | | | | | |
| Ex 16 | 80.65% | 19.00% | 0.35% | 81.11 | 169 |
| Ex 17 | 80.50% | 19.00% | 0.50% | 79.83 | 137 |
| Ex 18 | 80.35% | 19.00% | 0.65% | 80.48 | 117 |
| Ex 19 | 80.00% | 19.00% | 1.00% | 76.95 | 79 |
| Ex 20 | 79.00% | 19.00% | 2.00% | 19.59 | 36 |
| Ex 21 | 76.00% | 19.00% | 5.00% | 1.22 | 11 |
| Ex 22 | 73.50% | 19.00% | 7.50% | 1.24 | 4 |
| Ex 23 | 71.00% | 19.00% | 10.00% | 1.25 | 2 |

### Examples 24-28

Table 7 illustrates the range of the invention to include other acids. As can be seen in Comparative Example 8 (Table 6), the 81%/19% ratio of nylon and toughener would be expected to produce a notched Izod of about 80 kJ/m² and a melt viscosity of about 244 Pa-S. Table 7 shows the effect of substituting other organic acids.

In these examples, the nylon and toughener feeds were controlled by separate metering. The toughener polymer feed stream was FUSABOND® N MF521D (available commercially from E. I. DuPont deNemours & Co.). It was fed by a K-Tron loss-in-weight screw feeder running at 34.2 lb/hr. The 66-nylon feed stream was ZYTEL® 101 (available commercially from E. I. DuPont deNemours & Co.), and an organic acid. The organic acid used in each example is identified in Table The acids were dodecanedioic acid (available commercially from E. I. DuPont deNemours & Co.), phthalic anhydride (available commercially from Malinkrodt, Inc., St. Louis, Mo.), trimesic acid (available commercially from Sigma-Aldrich Co., Milwauke, Wis.), succinic acid (also available commercially from Sigma-Aldrich Co.) and citric acid (available commercially from J. T. Baker Co., Phillipsburg, N.J.).

The nylon and the organic acid were blended by tumbling in a drum and fed as one feed stream. This feed stream was fed into the extruder by a K-Tron loss-in-weight screw feeder running at 145.8 lb/hr. In these cases the melt blending occurred in a 40 mm Werner & Pfleiderer twin screw extruder operating 300 rpm screw speed with a high shear screw. The ingredients were all fed into barrel 1. A vacuum was applied at barrel 8. After exiting through a 4-hole die, the strands were quenched in an ambient water trough with circulating water. The strands were subsequently pelletized and allowed to cool under nitrogen sparge.

TABLE 7

| ID | Ex 24 | Ex 25 | Ex 26 | Ex 27 | Ex 28 |
|---|---|---|---|---|---|
| ZYTEL ® | 80.35% | 80.35% | 80.35% | 80.35% | 80.35% |
| 101 NC010 | | | | | |
| Fusabond ® | 19.00% | 19.00% | 19.00% | 19.00% | 19.00% |
| N MF521D | | | | | |
| DDDA | 0.65% | 0.00% | 0.00% | 0.00% | 0.00% |
| Phthalic Anhydride | 0.00% | 0.65% | 0.00% | 0.00% | 0.00% |
| Trimesic Acid | 0.00% | 0.00% | 0.65% | 0.00% | 0.00% |
| Succinic Acid | 0.00% | 0.00% | 0.00% | 0.65% | 0.00% |
| Citric Acid | 0.00% | 0.00% | 0.00% | 0.00% | 0.65% |
| Notched | 78.6 | 46.44 | 76.85 | 19.2 | 65.34 |
| Izod, DAM, | | | | | |
| 23° C., kJ/m² | | | | | |
| Melt Viscosity, Pa-S | 98 | 69 | 128 | 32 | 218 |

The data show that only DDDA and trimesic acid were successful in producing a high flow resin while maintaining resin toughness. On the other hand, while both phthalic anhydride and succinic acid produced high flow blends, unacceptable toughness reductions also occurred. Citric acid did not produce lowered viscosity. Those of skill in the art will recognize that these results can be remedied through sequential addition of the acids to the composition, thereby eliminating the occurrence of competing reactions.

### Examples 29-34

The following examples illustrate the effect of higher rubber loadings on the compositions. In these examples, the nylon and toughener feeds were controlled by separate metering. The toughener polymer feed stream was FUSABOND® N MF52 1D (available commercially from E. I. DuPont deNemours & Co.). It was fed by a K-Tron loss-in-weight screw feeder. The 66-nylon feed stream was ZYTEL® 101 (available commercially from E. I. DuPont deNemours & Co.), and dodecanedioic acid (available commercially from E. I. DuPont deNemours & Co.). This feed stream was fed into the extruder by a K-Tron loss-in-weight screw feeder. The rates of the two screw feeders were set to achieve the desired product composition. For example, in producing sample E100188-009-18, the nylon feed stream feeder was controlled at 97.2 lb/hr and the toughener feeder was controlled at 22.8 lb/hr. The ratio of the DDDA to nylon was maintained as a constant, so as the percentage of toughener increased, the percentages of nylon and DDDA decreased proportionally.

In these cases the melt blending occurred in a 40 mm Werner & Pfleiderer twin screw extruder operating 300 rpm screw speed with a high shear screw. The ingredients were all fed into barrel 1. A vacuum was applied at barrel 8. After exiting through a 4-hole die, the strands were quenched in an ambient water trough with circulating water. The strands were subsequently pelletized and allowed to cool under nitrogen sparge. The results are shown in Table 8.

TABLE 8

| ID | Ex 29 | Ex 30 | Ex 31 | Ex 32 | Ex 33 | Ex 34 |
|---|---|---|---|---|---|---|
| ZYTEL ® | 80.34% | 75.39% | 70.43% | 65.47% | 60.51% | 55.55% |
| 101 NC010 | | | | | | |
| Fusabond ® | 19.00% | 24.00% | 29.00% | 34.00% | 39.00% | 44.00% |
| N MF521D | | | | | | |
| DDDA | 0.66% | 0.61% | 0.57% | 0.53% | 0.49% | 0.45% |
| Notched | 76.39 | 86.1 | 88.58 | 81.32 | 67.39 | 60.02 |
| Izod, DAM, | | | | | | |
| 23° C., | | | | | | |
| kJ/m² | | | | | | |
| Notched | 67.34 | 85.85 | 91.82 | 90.14 | 77.24 | 73.54 |
| Izod, DAM, | | | | | | |
| 0° C., | | | | | | |
| kJ/m² | | | | | | |
| Melt Viscosity, | 105 | 141 | 174 | 202 | 199 | 217 |
| Pa-S, | | | | | | |

It should be expected that increasing levels of rubber would result in increasing melt viscosity. It may be noted from Table that the melt viscosity increases in proportion to the percent toughener up to 34% toughener and increases at a lower rate after that (But see Example 34?) Toughness was also maintained at these higher rubber loadings. This demonstrated that this invention is effective at higher loadings of rubber, up to and including 45%.

It is to be further appreciated that these compositions are adaptable to suit any number of processing techniques. For example, molders of toughened polyamide parts may find very different means of using these products to improve their existing injection molding processes. A molder using a multi-cavity mold to produce small parts may have difficulty completely filling the mold due to the limits of temperature, maximum machine pressure, and resin viscosity. A higher melt flow resin would allow use of even higher numbers of mold cavities without exceeding the machine's maximum injection pressures. In other cases, a manufacturer may have difficulties arising from high melt temperatures, such as part surface blemish defects commonly referred to as “ghosting.” While reductions of melt temperatures frequently alleviate such defects, certain manufacturers may be unable to operate successfully at lower melt temperatures due to the viscosity of the resin in use. A higher melt flow resin would allow molders to use lower melt temperatures and thereby eliminate part appearance defects.

1. A toughened polyamide composition comprising:
(a) 40-94 percent by weight polyamide;
(b) 6-60 percent by weight toughener having a tensile modulus of about 5.0 to 20,000 p.s.i. and wherein the ratio of the tensile modulus of the polyamide to the tensile modulus of the toughener is greater than 20 to 1, wherein the toughener is selected from the group consisting of [rubber and ionic copolymer] at least one polymer consisting essentially of polymerized ethylene, at least one polymerized α-olefin of 3 to 6 carbon atoms, and at least one polymerized unsaturated monomer taken from the class consisting of branched, straight chain and cyclic compounds having from 4 to 14 carbon atoms and at least one additional nonconjugated unsaturated carbon-carbon bond, and grafted thereto an unsaturated monomer taken from the class consisting of α,β-ethylenically unsaturated dicarboxylic acids having from 3 to 8 carbon atoms, and derivatives thereof taken from the class consisting of monoesters of alcohols of 1 to 29 carbon atoms, anhydrides of the dicarboxylic acids, the metal salts of the dicarboxylic acids and the monoesters of said dicarboxylic acid having from 0 to 100 percent of the carboxylic groups ionized by neutralization with metal ions; and at least one random copolymer consisting essentially of polymerized ethylene, alkyl acrylate selected from methyl and ethyl acrylate, and from about 0.0025-0.077 mole/100 g polymer of a mono alkyl ester of 1,4-butenedioic acid in which the alkyl group of the ester has 1 to 6 carbon atoms, said copolymer having from about 0.64-0.80 mole of (—CO₂—) units per 100 grams of copolymer, and having 0 to 100 percent of the esters of 1,4-butenedioic acid ionized by neutralization with metal ions selected from lithium, sodium, potassium, calcium and zinc ions, said copolymer having a melt index at 190° C. and a total load of 2160 grams of about 0.3 to 100 grams/10 minutes, and when neutralized having a melt flow rate of 0.04 to 100 grams/10 minutes under condition G of ASTM D 1238; and
(c) 0.35 to 10 percent by weight organic acid, with weight percentages based on the total weight of the composition.

2. The composition of claim 1 wherein said polyamide is selected from the group consisting of nylon-4,6, nylon-6,6, nylon-6,10, nylon-6,9, nylon-6,12, nylon-6, nylon-11, nylon-12, 6T through 12T, 6I through 12I, polyamides formed from 2-methylpentamethylene diamine with one or more acids selected from the group consisting of isophthalic acid and terephthalic acid, and blends and copolymers of said nylons and polyamides thereof.

3. The composition of claim 1 wherein the amount of said polyamide is 50-94 percent by weight, the amount of said toughener is 6-50 percent by weight, and the amount of said organic acid is 0.35 to 10 percent by weight.

4. The composition of claim 1 wherein the amount of said toughener is about 8 to about 40 percent by weight.

5. The composition of claim 3 wherein the amount of said toughener is about 10 to about 30 percent by weight.

6. The composition of claim 1 wherein said organic acid is selected from th group consisting of adipic acid, pimelic acid, suberic acid, azelaic acid, sebacic acid, undecanedioic acid, dodecanedioic acid, valeric acid, trimethylacetic acid, caproic acid, and caprylic acid.

7. The composition of claim 6 wherein said organic acid is dodecanedioic acid.

8. The composition of claim 1 wherein the amount of said organic acid is 0.35 to 2 weight percent.

9. A process for the preparation of toughened polyamide compositions exhibiting high flow and toughness, comprising melt-mixing 40-94 percent by weight polyamide, 6-60 percent by weight toughener selected from the group consisting of rubber and ionic copolymer, and 0.35 to 10 percent by weight organic acid, with weight percentages based on the total weight of the composition.

10. An article made from the composition of claim 1.

11. A process for the preparation of toughened polyamide compositions exhibiting high flow and toughness, comprising melt-mixing 40-94 percent by weight polyamide, 6-60 percent by weight toughener selected from the group consisting of rubber and ionic copolymer, and 0.35 to 10 percent by weight organic acid.

12. The process of claim 11 wherein said polyamide, said toughener, and said organic acid are melt-mixed in one step.

13. The process of claim 11 wherein a blend of said polyamide and said toughener is melt-mixed with said organic acid.

14. The process of claim 11 wherein said polyamide and said toughener are blended and said organic acid is subsequently melt-mixed therewith.

15. The process of claim 14 wherein said melt-mixing is accomplished by one or both of extrusion and molding.

16. The process of claim 11 wherein said organic acid is dodecanedioic acid.

17. The composition of claim 1 wherein the at least one polymer consisting essentially of polymerized ethylene, at least one polymerized α-olefin of 3 to 6 carbon atoms, and at least one polymerized unsaturated monomer is a copolymer of ethylene, propylene and 1,4-hexadiene having grafted thereto an unsaturated monomer taken from the class consisting of fumaric acid, maleic acid, maleic anhydride and the monoalkyl ester of said acids in which the alkyl group of the ester has 1 to 3 carbon atoms, said at least one polymer having an after grafting melt flow rate of 0.1 to 100 g/10 minutes, ASTM D 1238 at 280° C. and a total load of 2160 grams.

18. The composition of claim 1 wherein the at least one polymer consisting essentially of polymerized ethylene, at least one polymerized α-olefin of 3 to 6 carbon atoms, and at least one polymerized unsaturated monomer is a tetrapolymer of ethylene, propylene, 1,4-hexadiene and 2,5-norbomadiene having grafted thereto an unsaturated monomer taken from the class consisting of fumaric acid, maleic acid, maleic anhydride and the monoalkyl ester of said acids in which the alkyl group of the ester has 1 to 3 carbon atoms, said at least one polymer having an after grafting melt flow rate of 0.1 to 100 g/10 minutes, ASTM D 1238 at 280° C. and a total load of 2160 grams.

19. The composition of claim 1 wherein the toughener is ethylene/propylene/1,4 hexadiene-g-maleic anhydride. 20. (New) The composition of claim 1 wherein the toughener is ethylene/propylene/1,4 hexadiene-g-fumaric acid.
